(19) United States
(12) Patent Application Publication
(10) Pub. No.: US 2012/0051256 A1
(43) Pub. Date: Mar. 1, 2012

(54) WIRELESS COMMUNICATION TERMINAL AND WIRELESS COMMUNICATION METHOD

(75) Inventors: Yasuaki Yuda, Kanagawa (JP); Seigo Nakao, Kanagawa (JP); Daichi Imamura, Kanagawa (JP); Ayako Horiuchi, Kanagawa (JP)

(73) Assignee: PANASONIC CORPORATION, Osaka (JP)

(21) Appl. No.: 13/318,224

(22) PCT Filed: May 14, 2010
(86) PCT No.: PCT/JP2010/003290

§ 371 Date: Oct. 31, 2011

(30) Foreign Application Priority Data
May 15, 2009 (JP) 2009-119105

(51) Int. Cl. H04B 7/14; H04W 24/00; H04L 12/26

(52) U.S. Cl. 370/252; 370/315

(57) ABSTRACT

To measure the channel quality of adjacent cells with satisfactory precision without interference of a current cell. A wireless communication terminal of the invention is connected to a relay station and configured to receive data from at least one of the relay station, a base station, and another relay station different from the relay station. The wireless communication terminal includes a receiver which receives a signal including control information for measuring the channel quality of the non-connected base station or another non-connected relay station from the connected relay station, an extractor which extracts the control information from the signal received by the receiver, a measurement section which measures the channel quality of the non-connected base station or non-connected another relay station in a region, in which the connected relay station does not transmit other signals to the wireless communication terminal, on the basis of the control information, and a transmitter which transmits the measurement result of the channel quality of the non-connected base station or another non-connected relay station measured by the measurement section to the connected relay station.

### TECHNICAL FIELD

The present invention relates to a wireless communication terminal which is connected to a base station, and transmits and receives data with respect to the base station, and a wireless communication method.

### BACKGROUND ART

In the 3GPP (3rd Generation Partnership Project) which is the international standards organization of mobile communication, the standardization of LTE-Advanced (Long Term Evolution-Advanced, LTE-A) of a fourth-generation mobile communication system has started. In LTE-A, as described in Non Patent Literature 1, for the purpose of coverage expansion or capacity improvement, a relay technique is studied in which a radio signal is relayed using a relay station (Relay Node). For the purpose of cell edge throughput improvement, CoMP (Coordinated multiple point transmission and reception) is also studied in which a plurality of nodes are coordinated to transmit and receive data.

The relay technique is described with reference to FIG. 13. FIG. 13 is a diagram showing a wireless communication system which relays a radio signal using the relay technique. In FIG. 13, eNB denotes a base station, RN denotes a relay station, and UE denotes a wireless communication terminal. UE1 denotes a wireless communication terminal which is connected to eNB, and UE2 denotes a wireless communication terminal which is connected to RN.

In LTE-A, a method is studied in which, similarly to eNB, RN has an individual cell ID, such that, similarly to eNB, RN can be regarded as one cell from UE. eNB is connected to a network by wired communication, and RN is connected to eNB by wireless communication. A communication channel which connects RN and eNB is called a backhaul channel. Meanwhile, a communication channel which connects eNB or RN and UE is called an access channel.

In a downlink channel, for example, as shown in FIG. 13, RN receives a signal from eNB in a backhaul channel (in the figure, arrow A), and transmits a signal to UE2 in the access channel of RN (in the figure, arrow B). When the backhaul channel and the access channel are covered in the same frequency band, if RN performs transmission and reception simultaneously, self interference from transmission signal to reception signal occurs. For this reason, RN may not perform transmission and reception simultaneously. Accordingly, in LTE-A, a relay scheme is studied in which the backhaul channel and the access channel of RN are divided in time domains (in terms of subframes) and allocated.

The above-described relay scheme is described with reference to FIG. 14. FIG. 14 is a diagram showing the subframe configuration of a downlink channel in a relay scheme. In the figure, symbols [n, n+1, . . . ] represent subframe numbers, and boxes represent downlink channel subframes. FIG. 14 also shows the transmission subframe of eNB (shaded portion), the reception subframe of UE1 (blank portion), the transmission subframe of RN (right hatched portion), and the reception subframe of UE2 (left hatched portion).

As indicated by an arrow (bold line) of FIG. 14, signals are transmitted from eNB in all the subframes [n, n+1, . . . , n+6]. As indicated by an arrow (bold line) or an arrow (broken line) of FIG. 14, UE1 can receive a signal in all the subframes. Meanwhile, as indicated by an arrow (broken line) or an arrow (thin line) of FIG. 14, in RN, a signal is transmitted in the subframes excluding the subframe numbers [n+2, n+6]. As indicated by an arrow (thin line) of FIG. 14, UE2 can receive a signal in the subframes excluding the subframe numbers [n+2, n+6]. RN receives a signal from eNB in the subframes of the subframe numbers [n+2, n+6]. That is, in RN, the subframes of the subframe numbers [n+2, n+6] serves as the backhaul channel, and other subframes serves as the access channel of RN.

However, in the subframes [n+2, n+6] in which RN serves as backhaul, if RN does not transmit a signal from eNB, a measurement operation to measure the quality of RN is not performed in a wireless communication terminal of LTE which does not know the presence of RN. As a method which solves the above problem, in LTE-A, the use of an MBSFN (Multicast/Broadcast over Single Frequency Network) subframe which is defined in LTE is studied.

An MBSFN subframe is a subframe which is prepared for realizing an MBMS (Multimedia Broadcast and Multicast Service) in the future. The MBSFN subframe is defined such that cell-specific control information is transmitted in the top two symbols, and a signal for an MBMS is transmitted in a region since a third symbol. For this reason, a wireless communication terminal of LTE can perform measurement using the top two symbols in the MBSFN subframe.

The MBSFN subframe can be used in a pseudo manner in an RN cell. That is, in the RN cell, RN cell-specific control information is transmitted in the top two symbols of the MBSFN subframe, and data for an MBMS is not transmitted and a signal from eNB is received in a region since the third symbol. For this reason, in an RN cell, an MBSFN subframe can be used as the reception subframe of the backhaul channel. As described above, an MBSFN subframe used in a pseudo manner in an RN cell is hereinafter called “an MBSFN subframe to be used as backhaul by RN”.

Next, CoMP is described with reference to FIG. 15. FIG. 15 shows CoMP of a downlink channel. In FIG. 15, a base station (hereinafter, referred to as eNB) and a relay station (hereinafter, referred to as RN) transmit data to one user equipment (hereinafter, referred to as UE) in a coordinated manner, as indicated by arrows C and D. In LTE-A, various studies are conducted as a scheme for CoMP, and, for example, there are Dynamic Cell Selection (DCS), Joint Transmission (JT), and the like.

Here, “DCS” is a method in which, from among a plurality of nodes, a node which transmits data is selected dynamically and transmission is performed. “JT” is a method in which a plurality of nodes transmit the same signal simultaneously.

Taking into consideration CoMP by eNB and RN in the downlink channel shown in FIG. 15, in order that CoMP is applied and adaptive (dynamic) channel control is performed, the channel quality from eNB to UE and the channel quality from RN to UE are necessary. In UE which is connected to RN, since RN serves as a current cell, the CQI (Channel Quality Indicator) described in Non Patent Literature 2 can be used for the channel quality from RN to UE. Meanwhile, since eNB serves as an adjacent cell, the CQI can be used for the channel quality from eNB to UE.

Here, “CQI” (Channel Quality Indicator) is the channel quality of a receiving circuit when viewed from the reception side. The CQI is fed back from the reception side to the transmission side, and the transmission side selects the modulation scheme and the code rate of a signal to be transmitted to the reception side.

As a method of measuring the channel quality of an adjacent cell, for example, there is a measurement which is used at the time of handover described in Non Patent Literature 3. In intra-frequency measurement of LTE, UE measures the channel quality of an adjacent cell having the same frequency as the frequency of a cell being connected. For this reason. UE can measure the channel quality of an adjacent cell without changing the center frequency of a reception band. Since UE does not change the reception frequency, it is not necessary for a cell to provide the time (measurement gap) at which transmission is not performed in the downlink channel for UE measurement. For this reason, UE measures the channel quality of an adjacent cell through determination of UE using the time, at which a signal is not transmitted from a current cell to UE, or the like with no allocation to UE.

### CITATION LIST

### Non Patent Literature

Non Patent Literature 1: 3GPP TR 36.814 v0.4.1 (2009-02), “Further Advancements for E-UTRA Physical Layer Aspects (Release 9)”
Non Patent Literature 2: 3GPP TS 36.213 v8.5.0 (2008-12), “Physical Layer Procedures (Release 8)”
Non Patent Literature 3: 3GPP TS 36.300 v8.7.0 (2008-12), “Overall Description; Stage 2 (Release 8)”

### SUMMARY OF INVENTION

### Technical Problem

However, in UE which is connected to RN, the channel quality of an adjacent cell is changed depending on the presence/absence of a signal from RN. For this reason, UE which is not connected to RN may not measure the channel quality of an adjacent cell with satisfactory precision in a state where there is no interference from RN, and channel control is not performed.

An object of the invention is to provide a wireless communication terminal and a wireless communication method capable of measuring the channel quality of an adjacent cell with satisfactory precision without interference of a current cell.

### Solution to Problem

The invention provides a wireless communication terminal which is connected to a relay station and configured to receive data from at least one of the relay station, a base station, and another non-connected relay station different from the relay station, the wireless communication terminal including: a receiver which receives a signal including control information for measuring a channel quality of the non-connected base station or the another non-connected relay station from the connected relay station; an extractor which extracts the control information from the signal received by the receiver; a measurement section which measures the channel quality of the non-connected base station or the another non-connected relay station in a region, in which the connected relay station does not transmit another signal to the wireless communication terminal, based on the control information; and a transmitter which transmits a measurement result of the channel quality of the non-connected base station or the another non-connected relay station measured by the measurement section to the connected relay station.

In the wireless communication terminal, the measurement section measures the channel quality of the non-connected base station or the another non-connected relay station in a region, in which the connected relay station receives a signal from the base station as backhaul, based on the control information.

In the wireless communication terminal, the measurement section measures the channel quality of the non-connected base station or the another non-connected relay station in an MBSFN subframe to be used by the connected relay station as the backhaul, based on the control information.

In the wireless communication terminal, the measurement section measures the channel quality of the non-connected base station or the another non-connected relay station in a region since a third symbol excluding top two symbols in the MBSFN subframe to be used by the connected relay station as the backhaul, based on the control information.

In the wireless communication terminal, the measurement section measures the channel quality of the non-connected base station or the another non-connected relay station multiple times in the region, in which the connected relay station does not transmit the another signal to the wireless communication terminal, based on the control information, and averages measurement results.

In the wireless communication terminal, the measurement section measures the channel quality of the another non-connected relay station in a region since a third symbol excluding top two symbols in an MBSFN subframe to be used by the connected relay station as backhaul, based on the control information, and the measurement section measures the channel quality of the connected relay station in a region since a third symbol excluding top two symbols in an MBSFN subframe to be used as backhaul by the another non-connected relay station.

The invention provides a wireless communication method for a wireless communication terminal, which is connected to a relay station and configured to receive data from at least one of the relay station, a base station, and another relay station different from the relay station, the wireless communication method including: receiving a signal including control information for measuring a channel quality of the non-connected base station or the another non-connected relay station from the connected relay station; extracting the control information from the received signal; measuring the channel quality of the non-connected base station or the another non-connected relay station in a region, in which the connected relay station does not transmit another signal to the wireless communication terminal, based on the control information; and transmitting a measurement result of the channel quality of the non-connected base station or the another non-connected relay station to the connected relay station.

### ADVANTAGEOUS EFFECTS OF INVENTION

According to the wireless communication terminal and the wireless communication method of the invention, it is possible to measure the channel quality of an adjacent cell with satisfactory precision without interference of a current cell.

### BRIEF DESCRIPTION OF DRAWINGS

FIG. 1 is a diagram showing a wireless communication system, which relays a radio signal using a relay technique, in an embodiment of the invention.

FIG. 2 is a diagram showing “an MBSFN subframe to be used as backhaul by RN” in the embodiment.

FIG. 3 is a diagram showing a subframe in which UE under RN measures a CQI.

FIG. 4 is a diagram showing a downlink channel subframe in the embodiment.

FIG. 5 is a block diagram showing the configuration of a wireless communication terminal 300 in the embodiment.

FIG. 6 is a block diagram showing the configuration of a wireless relay station apparatus 200 in the embodiment.

FIG. 7 is a diagram showing a process flow of CoMP channel quality measurement of UE in the embodiment.

FIG. 8 is a diagram showing a wireless communication system, which relays a radio signal using a relay technique, in a modification of the embodiment.

FIG. 9 is a diagram showing a downlink channel subframe in the modification of the embodiment.

FIG. 10 is a block diagram showing the configuration of a wireless communication terminal 600 in the modification of the embodiment.

FIG. 11 is a block diagram showing the configuration of a wireless relay station apparatus 500 in the modification of the embodiment.

FIG. 12 is a diagram showing a process flow of CoMP channel quality measurement of UE in the modification of the embodiment.

FIG. 13 is a diagram showing a wireless communication system which relays a radio signal using a relay technique.

FIG. 14 is a diagram showing the configuration of a downlink channel subframe in a relay scheme.

FIG. 15 is a diagram showing CoMP of a downlink channel.

### DESCRIPTION OF EMBODIMENTS

Hereinafter, an embodiment of the invention is described with reference to the drawings.

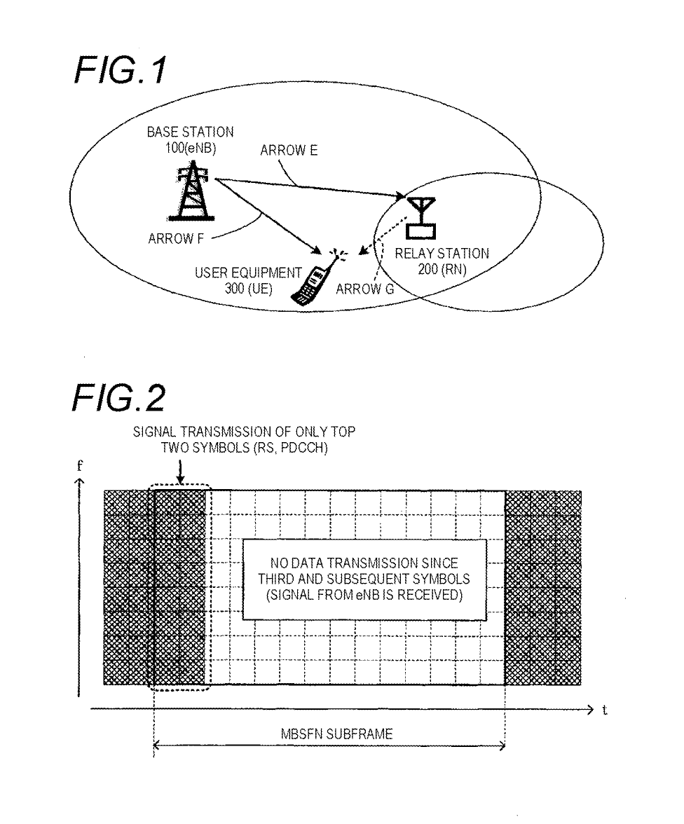

FIG. 1 is a diagram showing a wireless communication system, which relays a radio signal using a relay technique, in an embodiment of the invention. In the embodiment, referring to FIG. 1, eNB denotes a base station 100, RN denotes a wireless relay station apparatus 200, and UE denotes a wireless communication terminal 300. It is assumed that the wireless communication terminal 300 is a wireless communication terminal which is connected to the wireless relay station apparatus 200 (RN).

Hereinafter, in the embodiment, as shown in FIG. 1, a case where a radio signal is relayed is described. That is, the base station 100 (hereinafter, referred to as eNB) and the relay station 200 (hereinafter, referred to as RN) transmit data to one user equipment 300 (hereinafter, referred to as UE) in a coordinated manner, as indicated by arrows F and G. RN receives a signal from eNB in a backhaul channel (arrow E).

It is assumed that the relay station 200 (RN) has an individual cell ID which is studied in LTE-A. For this reason, the relay station 200 (RN) adjacent to the wireless communication terminal 300 can be regarded as an adjacent cell when viewed from the wireless communication terminal 300.

In the embodiment, “the MBSFN subframe to be used as backhaul by RN” refers to an MBSFN subframe such that, in an RN cell, RN cell-specific control information is transmitted in the top two symbols of the MBSFN subframe, and data for MBMS is not transmitted and a signal from eNB is received in a region since the third symbol.

In the embodiment, a relay scheme is used in which the backhaul channel and the access channel are covered in the same frequency band, and the backhaul channel and the access channel of RN are divided in time domains (in terms of subframes) and allocated.

When UE which is connected to RN measures the channel quality of an adjacent cell, a signal from RN serving as a current cell becomes an interference signal. When “the MBSFN subframe to be used as backhaul by RN” is used in RN, in “the MBSFN subframe to be used as backhaul by RN”, there is no transmission signal from RN. For this reason, in UE which is connected to RN, there is no interference from RN in “the MBSFN subframe to be used as backhaul by RN”, thereby measuring the channel quality of an adjacent cell with satisfactory precision. Taking into consideration the use in “the MBSFN subframe to be used as backhaul by RN”, it is possible to specify a region where a signal is not transmitted from RN to UE from the viewpoint of subframes and the viewpoint of symbols.

First, from the viewpoint of subframes, the reason that a region where a signal is not transmitted from RN to UE can be specified in “the MBSFN subframe to be used as backhaul by RN” is described.

If “the MBSFN subframe to be used as backhaul by RN” is used, the interference amount is changed in terms of subframes. In LTE, the MBSFN subframe is allocated at the determined position, and can be set individually for each cell. The allocation position of the MBSFN subframe is notified from eNB or RN to UE as system information in SIB2 (System Information Block 2), and is changed in a comparatively long period, not being changed instantaneously, unlike user allocation. For this reason, even when “the MBSFN subframe to be used as backhaul by RN” is used, the position of the MBSFN subframe is set individually for each cell (RN).

That is, even in UE under eNB, if an MBSFN subframe which is used as backhaul of adjacent RN, it can be specified that the subframe is a subframe in which there is a small amount of interference from RN.

Next, the reason that a region where a signal is not transmitted from RN can be specified in “the MBSFN subframe to be used as backhaul by RN” from the viewpoint of symbols is described with reference to FIG. 2. FIG. 2 is a diagram showing “the MBSFN subframe to be used as backhaul by RN” in the embodiment.

As shown in FIG. 2, in “the MBSFN subframe to be used as backhaul by RN”, a signal, such as cell-specific control information, is transmitted in the top two symbols, and transmission is switched to reception and a signal from eNB is received since the third symbol.

When viewed from UE under eNB, in the MBSFN subframe shown in FIG. 2, the top two symbols may be regarded as interference, but there is no interference in the region since the third symbol. That is, the interference amount is changed between the region of the top two symbols and the region since the third symbol. Accordingly, even in UE under eNB, if “the MBSFN subframe to be used as backhaul by RN” is known to adjacent RN, it is possible to specify a symbol with a small amount of interference from RN in the MBSFN subframe.

In LTE, it is assumed that adjacent cells are out of synchronization. For this reason, when measuring the channel quality of adjacent cells, UE should perform reception for a comparatively long time so as to be synchronized with an adjacent cell. For example, for frame synchronization and subframe synchronization, a synchronization signal which is transmitted in the subframes #0 and #5 should be received, and reception should be performed in at least six subframes. However, the subframe of backhaul which is transmitted from eNB and the MBSFN subframe which is used as reception of backhaul in RN should be in synchronization between eNB and RN which is connected to eNB. For this reason, at least subframe synchronization is necessary.

For this reason, it should suffice that, even when eNB to which RN is connected is an adjacent cell, UE which is connected to RN takes symbol synchronization depending on a difference in a propagation delay time, thereby taking synchronization in a subframe without needing multiple subframes.

When RN notifies UE under RN of the position of the MBSFN subframe to be used as backhaul of RN, and CoMP is performed between RN and eNB to which RN is connected, UE under RN can measure the channel quality of eNB, that is, the CQI for CoMP using a signal of a region since the third symbol in the MBSFN subframe to be used as backhaul of RN.

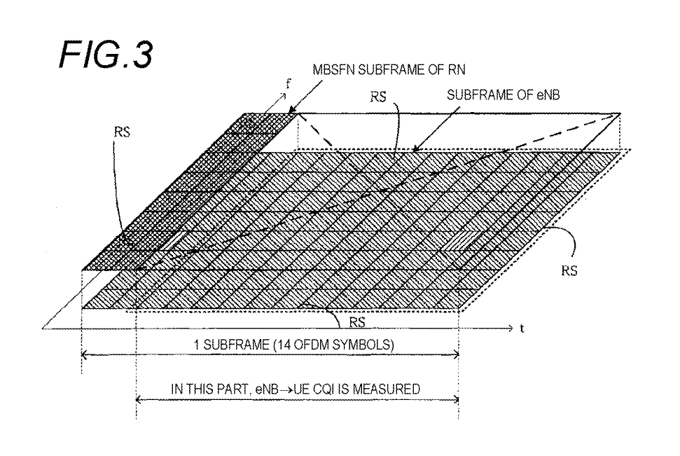

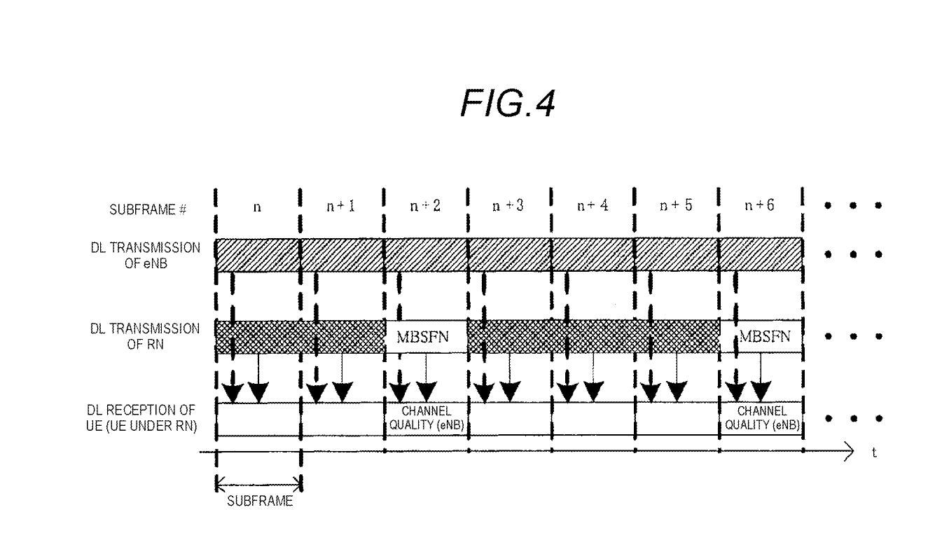

Hereinafter, an example of a method of measuring a CQI for CoMP in the embodiment is described with reference to FIGS. 3 and 4.

First, RN notifies UE under RN of the position of “the MBSFN subframe to be used as backhaul by RN”. As a notification method, for example, a method is known in which a notification is made using system information (System Information Block, SIB) in LTE, control information of an upper level layer, or the like. In LTE, the configuration of the MBSFN subframe is notified in SIB2 (System Information Block Type 2) which is one of the system information. However, in this notification method, whether or not the MBSFN subframe is used as backhaul of RN is not known to UE. Accordingly, the configuration of “the MBSFN subframe to be used as backhaul by RN” is notified along with the configuration of the MBSFN subframe.

Next, a subframe in which UE under RN measures a CQI is described with reference to FIG. 3. FIG. 3 is a diagram showing a subframe in which UE under RN measures a CQI.

In UE under RN, a channel quality measurement mode is provided in which the channel quality from eNB serving as an adjacent cell to UE using a region since the third symbol excluding the top two symbols in the subframe shown in FIG. 3. As the channel quality measurement, there are channel quality measurement (CQI measurement) using channel control, channel quality measurement using handover, and the like. In the embodiment, as the channel quality measurement from eNB to UE, a case which a CQI is measured is described.

In “the MBSFN subframe to be used as backhaul by RN”, UE under RN measures the channel quality (the CQI of eNB) from eNB serving as an adjacent cell to UE in the channel quality measurement mode described with reference to FIG. 3.

FIG. 4 shows a downlink channel subframe in the embodiment. In FIG. 4, symbols [n, n+1, . . . ] represent subframe numbers, and boxes represent downlink channel subframes. In the subframes [n+2, n+6] serving as “the MBSFN subframe to be used as backhaul by RN”, UE under RN measures the CQI of eNB in the channel quality measurement mode described with reference to FIG. 3.

In the embodiment, if the above-described CQI measurement method for CoMP is used, in UE under RN, it is possible to measure the channel quality of eNB when there is no interference from RN with satisfactory precision. For this reason, when CoMP is performed between eNB and RN which is connected to eNB, channel control according to the channel quality is performed.

As a specific example of CoMP, DCS (Dynamic Cell Selection) and JT (Joint Transmission) is described.

(Specific Example of CoMP 1: DCS)

A case regarding DCS is described. As DCS which is performed on UE under RN when RN exists, in “the MBSFN subframe to be used as backhaul by RN”, a DL signal is transmitted from eNB to which RN is connected to UE under RN, such that DCS can be realized as follows.

First, UE under RN measures the channel quality (the CQI of eNB) from eNB to which RN is connected to UE in “the MBSFN subframe to be used as backhaul by RN” using the CQI measurement method for CoMP described with reference to FIGS. 3 and 4. UE under RN feeds back, to RN to which UE is connected, the measured channel quality from eNB to which RN is connected to UE.

RN to which UE is connected performs control such that data is transmitted from eNB to UE under RN in “the MBSFN subframe to be used as backhaul by RN” using the feedback channel quality information. RN to which UE is connected transmits data from RN to UE under RN in other subframes. For this reason, RN to which UE is connected can transmit data from eNB to UE under RN in the subframe serving as “the MBSFN subframe to be used as backhaul by RN”, thereby improving user throughput of UE under RN.

(Specific Example 2 of CoMP: JT)

Next, a case regarding JT is described. JT can be realized by transmitting the same signal from RN and eNB to which RN is connected simultaneously and combining the signals in UE.

In LTE-A, similarly to a case where “the MBSFN subframe to be used as backhaul by RN” is used, a method of realizing the above-described JT in the MBSFN subframe is studied. This is because, when JT is performed, it is necessary to make the reference signals of a plurality of cells to be transmitted simultaneously, and in a normal subframe, there is an influence on a cell-specific reference signal. Hereinafter, an MBSFN subframe which realizes JT is referred to as “an MBSFN subframe to be used in CoMP” and distinguished from “the MBSFN subframe to be used as backhaul by RN”.

In LTE-A, information for distinguishing “MBSFN subframe to be used as backhaul by RN” and “the MBSFN subframe to be used in CoMP” from each other is notified from RN to UE, UE of LTE-A can distinguish “the MBSFN subframe to be used as backhaul by RN” and “the MBSFN subframe to be used in CoMP” from each other.

First, UE under RN measures the channel quality (the CQI of eNB) from eNB to which RN is connected to UE in “the MBSFN subframe to be used as backhaul by RN” using the CQI measurement method for CoMP described with reference to FIGS. 3 and 4. This is because, in JT, received power of UE under RN becomes power “power from RN+ power from eNB”, such that the channel quality from eNB serving as an adjacent cell to UE should be known with satisfactory precision so as to perform channel control according to the combined channel quality in US under RN.

UE under RN feeds back, to RN, the channel quality (the CQI of eNB) measured by the CQI measurement method for CoMP described with reference to FIGS. 3 and 4. RN performs control such that the same data is transmitted from RN and eNB to which RN is connected simultaneously in “the MBSFN subframe to be used in CoMP” using the feedback channel quality (the CQI of eNB). For this reason, the reception SINR of UE transmitted by JT is improved, thereby improving user throughput of UE under RN.

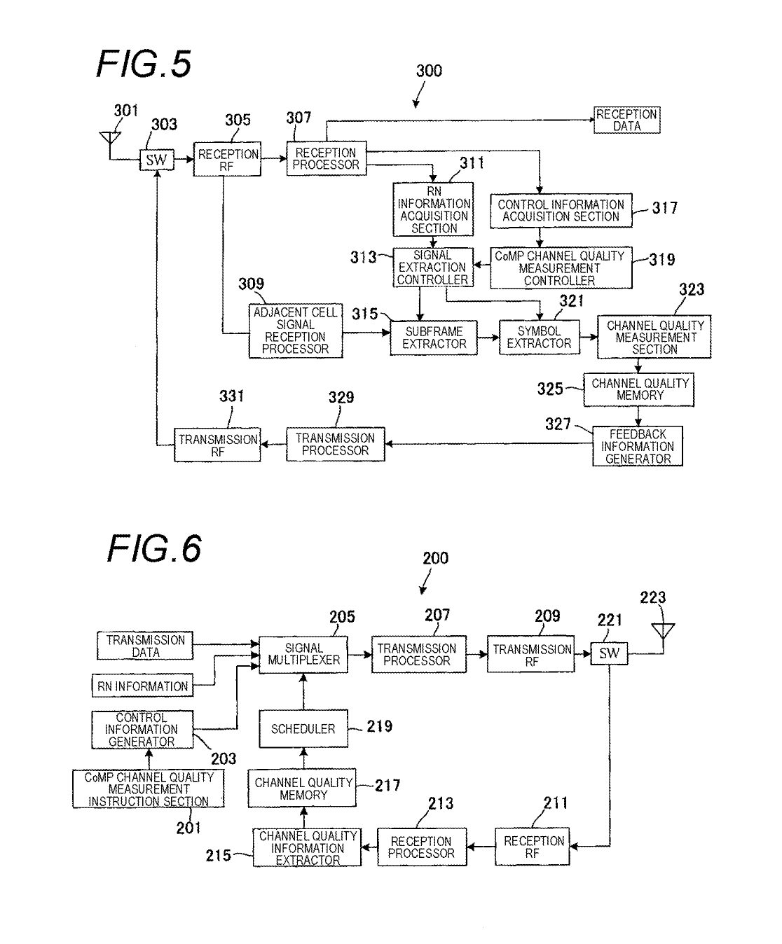

Next, the configuration of the wireless communication terminal 300 in the embodiment is described with reference to FIG. 5. FIG. 5 is a block diagram showing the configuration of the wireless communication terminal 300 in the embodiment. The wireless communication terminal 300 shown in FIG. 5 includes an antenna 301, a switch (SW) 303, a reception RF section 305, a reception processor 307, an adjacent cell signal reception processor 309, an RN information acquisition section 311, a signal extraction controller 313, a subframe extractor 315, a control information acquisition section 317, a CoMP channel quality measurement controller 319, a symbol extractor 321, a channel quality measurement section 323, a channel quality memory 325, a feedback information generator 327, a transmission processor 329, and a transmission RF section 331.

The reception RF section 305 performs a filter process of removing a signal outside a communicating band from signals received by the antenna 301, performs frequency conversion to an IF frequency band or a baseband, and outputs the result to the reception processor 307 and the adjacent cell signal reception processor 309.

The reception processor 307 performs a reception process of receiving a signal output from the reception RF section, and separates and outputs data multiplexed into the received signal, control information, and information relating to RN. Specifically, the reception processor 307 converts an analog signal to a digital signal by an AD converter or the like, and performs a demodulation process, a decoding process, and the like.

The adjacent cell signal reception processor 309 performs a reception process of receiving a signal from an adjacent cell from among the signals output from the reception RF section 305, and outputs the received signal to the subframe extractor 315. Although the same process as in the reception processor 307 is performed, the process in the adjacent cell signal reception processor 309 is different from the process in the reception processor 307 in that a process specific to the adjacent cell is performed. Specifically a reception process of receiving a reference signal or the like is performed. In LTE, since a reference signal is transmitted in a cell-specific sequence, the adjacent cell signal reception processor 309 performs a reception process of receiving a reference signal based on the sequence of the adjacent cell. The subsequent channel quality measurement section 323 measures the channel quality of the adjacent cell using an output signal of the adjacent cell signal reception processor 309. For example, the adjacent cell signal reception processor 309 outputs a reference signal when measuring a desired signal component and outputs a data signal when measuring an interference component.

The control information acquisition section 317 acquires control information of the wireless communication terminal 300 from the control information separated in the reception processor 307, and outputs control information relating to the quality measurement of an adjacent cell for CoMP from the control information to the CoMP channel quality measurement controller 319.

When an instruction to perform the quality measurement of the adjacent cell for CoMP is received by the control information relating to the quality measurement of the adjacent cell for CoMP output from the control information acquisition section 317, the CoMP channel quality measurement controller 319 outputs an instruction to perform the quality measurement of the adjacent cell to the signal extraction controller 313.

The RN information acquisition section 311 acquires information relating to RN separated in the reception processor 307, and outputs the information to the signal extraction controller 313. The information relating to RN includes the position of “the MBSFN subframe to be used as backhaul by RN”.

The signal extraction controller 313 outputs an instruction to the subframe extractor 315 and the symbol extractor 321 on the basis of the instruction of the CoMP channel quality measurement controller 319 using the information relating to RN output from the RN information acquisition section 311. When the CoMP channel quality measurement controller 319 instructs to perform the quality measurement of the adjacent cell for CoMP, the signal extraction controller 313 instructs the subframe extractor 315 to extract “the MBSFN subframe to be used as backhaul by RN” output from the RN information acquisition section 311 from an adjacent cell signal output from the adjacent cell signal reception processor 309. When the CoMP channel quality measurement controller 319 instructs to perform the quality measurement of the adjacent cell for CoMP, the signal extraction controller 313 instructs the symbol extractor 321 to extract a region since the third symbol excluding the top two symbols in “the MBSFN subframe to be used as backhaul by RN”.

The subframe extractor 315 extracts the adjacent cell signal output from the adjacent cell signal reception processor 309 in a subframe unit on the basis of the instruction of the signal extraction controller 313, and outputs the adjacent cell signal to the symbol extractor 321.

The symbol extractor 321 extracts the adjacent cell signal in a subframe unit extracted by the subframe extractor 315 in a symbol region on the basis of the instruction of the signal extraction controller 313, and outputs the adjacent cell signal to the channel quality measurement section 323.

The channel quality measurement section 323 performs the channel quality measurement of the adjacent cell for CoMP using the adjacent cell extracted by the symbol extractor 321, and outputs the result to the channel quality memory 325. For example, when measuring a desired signal component of the adjacent cell, as the method of measuring the channel quality of the adjacent cell for CoMP, the channel quality measurement section 323 performs channel estimation using the reference signal of the adjacent cell, and measures received power of a desired signal component of the adjacent cell from the channel estimation result. When measuring an interference component, as a method of measuring the channel quality of the adjacent cell for CoMP, the channel quality measurement section 323 measures received power using a data region and subtracts received power of data of the adjacent cell from the measured received power to measure received power of the interference component. When measuring an interference component, received power of data of the adjacent cell can be obtained from the above-described received power of the desired signal component of the adjacent cell.

The channel quality memory 325 stores the channel quality of the adjacent cell for CoMP measured by the channel quality measurement section 323, and outputs the channel quality to the feedback information generator 327.

The feedback information generator 327 generates feedback information to be fed back to the wireless relay station apparatus 200 using the channel quality of the adjacent cell for CoMP stored in the channel quality memory 325 at the timing at which the feedback information is transmitted, and outputs the feedback information to the transmission processor 329. The timing at which the wireless communication terminal 300 transmits information to be fed back to the wireless relay station apparatus 200 may be a periodic timing defined in advance or a specific timing. The specific timing may be notified by control information, and may be instructed from the CoMP channel quality measurement controller 319 to the feedback information generator 327.

The transmission processor 329 performs a transmission process such that the feedback information generated by the feedback information generator 327 can be fed back to the wireless relay station apparatus 200, and outputs the feedback information to the transmission RF section 331. The transmission process which is performed by the transmission processor 329 includes, for example, multiplexing of a signal, such as transmission data or feedback information, an encoding process, or a modulation process.

The transmission RF section 331 performs frequency conversion to an RF frequency, power amplification, and a transmission filter process on a transmission signal transmitted from the transmission processor 329, and outputs the result to the antenna 301.

Next, the configuration of the wireless relay station apparatus 200 of the embodiment is described with reference to FIG. 6. FIG. 6 is a block diagram showing the configuration of the wireless relay station apparatus 200 of the embodiment. The wireless relay station apparatus 200 shown in FIG. 6 includes a CoMP channel quality measurement instruction section 201, a control information generator 203, a signal multiplexer 205, a transmission processor 207, a transmission RF section 209, a reception RF section 211, a reception processor 213, a channel quality information extractor 215, a channel quality memory 217, a scheduler 219, a switch 221, and an antenna 223.

Transmission data shown in FIG. 6 is prepared for each user equipment, and is input to the signal multiplexer 205. RN information is basically information relating to the relay station apparatus 200, and is input to the signal multiplexer 205.

The CoMP channel quality measurement instruction section 201 outputs an instruction to measure the channel quality of an adjacent cell for CoMP to the control information generator 203 for the wireless communication terminal 300 to which CoMP is applied.

The control information generator 203 generates control information relating to each wireless communication terminal including the instruction to measure the channel quality of the adjacent cell output from the CoMP channel quality measurement instruction section 201, and outputs the control information to the signal multiplexer 205.

The signal multiplexer 205 multiplexes input transmission data, the RN information, and the control information for each wireless communication terminal, and outputs the result to the transmission processor 207. The signal multiplexer 205 arranges transmission data for each wireless communication terminal on the basis of scheduling information output from the scheduler 219 described below and performs user multiplexing to multiplex transmission data into other signals.

The transmission processor 207 performs a transmission process of transmitting a signal multiplexed by the signal multiplexer 205 to output the signal to the transmission RF section 209. The transmission process of the transmission processor 207 includes, for example, an encoding process and a modulation process.

The transmission RF section 209 performs frequency conversion to an RF frequency, power amplification, and a transmission filter process on the transmission signal transmitted from the transmission processor 207, and outputs the result to the antenna 223.

The reception RF section 211 performs a filter process of removing a signal outside a communicating band from signals received by the antenna 223, performs frequency conversion to an IF frequency band or a baseband, and outputs the result to the reception processor 213.

The reception processor 213 performs a reception process of receiving a signal output from the reception RF section 211, and separates reception data, control information, and the like. Specifically, the reception processor 213 converts an analog signal to a digital signal by an AD converter or the like, and performs a demodulation process, a decoding process, and the like.

The channel quality information extractor 215 extracts channel quality information of the adjacent cell for CoMP from the control information separated by the reception processor 213, and outputs the channel quality information to the channel quality memory 217.

The channel quality memory 217 stores the channel quality information of the adjacent cell for CoMP extracted by the channel quality information extractor 215, and outputs the channel quality information to the scheduler 219.

The scheduler 219 performs scheduling for CoMP transmission between the adjacent cell and the relay apparatus (current cell) using the channel quality information of the adjacent cell for CoMP stored in the channel quality memory 217 and channel quality information relating to the relay station apparatus (current cell) (not shown), and outputs scheduling information to the signal multiplexer 205. During the scheduling, a transmission subframe and a transmission frequency (a resource block) are determined using the channel quality information of the adjacent cell for CoMP stored in the channel quality memory 217 and the channel quality information relating to the relay station apparatus (current cell) (not shown).

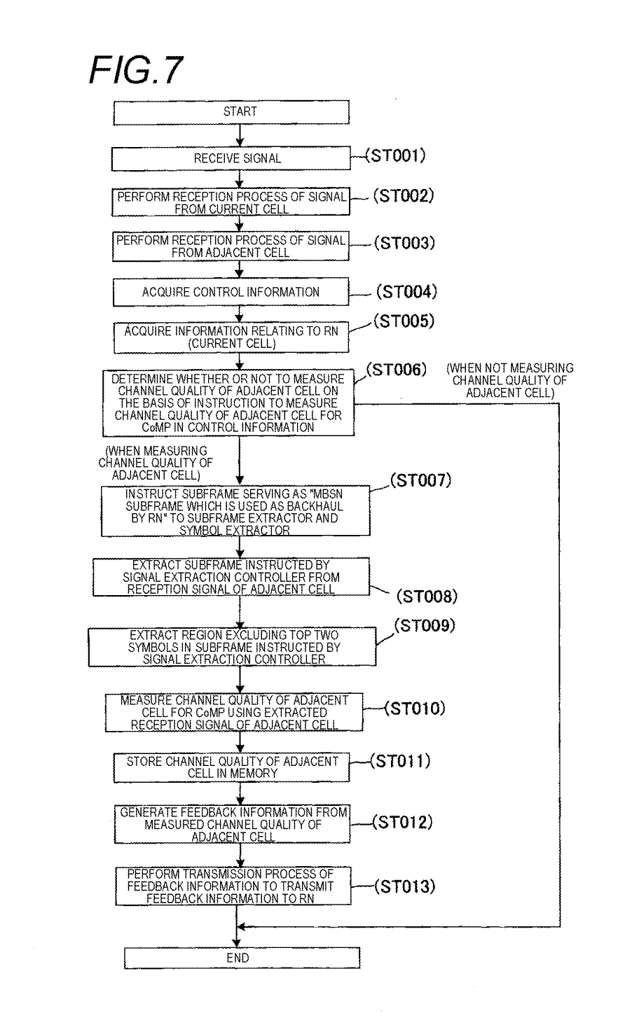

Next, a process flow of channel quality measurement for CoMP in the wireless communication terminal 300 of the embodiment is described with reference to FIG. 7. FIG. 7 is a diagram showing a process flow of channel quality measurement for CoMP of UE.

In Step (ST001), the reception RF section 305 receives signals and performs a reception RF process. In Step (ST002), the reception processor 307 performs a reception process of receiving a signal from the current cell from among the signals subjected to the reception RF process in Step (ST001).

In Step (ST003), the adjacent cell signal reception processor 309 performs a reception process of receiving a signal from the adjacent cell from among the signals subjected to the reception RF process in Step (ST001). In Step (ST004), the control information acquisition section 317 acquires control information for UE from the signal received in Step (ST002).

In Step (ST005), the RN information acquisition section 311 acquires information relating to RN from the signal received in Step (ST002).

In Step (ST006), the CoMP channel quality measurement controller 319 determines whether or not to perform the channel quality measurement of the adjacent cell for CoMP on the basis of the instruction to measure the channel quality of the adjacent cell for CoMP by the control information acquired in Step (ST004). When determined to measure the channel quality of the adjacent cell for CoMP, the process progresses to Step (ST007). When the channel quality of the adjacent cell is determined not to be measured, the process ends.

In Step (ST007), the signal extraction controller 313 instructs a subframe serving as “the MBSFN subframe to be used as backhaul by RN” from the information relating to RN acquired in Step (ST005) to the subframe extractor 315 and the symbol extractor 321.

In Step (ST008), the subframe extractor 315 extracts the subframe from the signal of the adjacent cell processed in Step (ST003) in the subframe serving as “the MBSFN subframe to be used as backhaul by RN” instructed from the signal extraction controller 313 in Step (ST007).

In Step (ST009), the symbol extractor 321 extracts a signal of a region excluding the top two symbols from the signal of the subframe extracted in Step (ST008) in the subframe serving as “the MBSFN subframe to be used as backhaul by RN” notified from the signal extraction controller 313 in Step (ST007).

In Step (ST010), the channel quality measurement section 323 performs the channel quality measurement of the adjacent cell for CoMP using the signal extracted in Step (ST009).

In Step (ST011), the channel quality memory 325 stores the channel quality of the adjacent cell for CoMP measured in Step (ST010).

In Step (ST012), the feedback information generator 327 generates feedback information from the channel quality of the adjacent cell for CoMP stored in Step (ST011). In Step (ST013), the transmission processor 329 and the transmission RF section 331 performs a transmission process of transmitting the feedback information generated in Step (ST012) to transmit the feedback information to R.N.

As described above, in the embodiment, if the above-described CQI measurement method for CoMP, in UE under RN, it is possible to measure the channel quality of eNB with satisfactory precision without interference from RN. For this reason, when CoMP is performed between eNB and RN which is connected to eNB, channel control based on the channel quality is performed.

In the embodiment, UE under RN may measure the CQI of the adjacent cell in “the MBSFN subframe to be used as backhaul by RN” multiple times, and may average the CQIs. Therefore, it is possible to improve the CQI measurement precision.

Although in the embodiment, “the MBSFN subframe to be used as backhaul by RN” has been described, similarly to “the MBSFN subframe to be used as backhaul by RN”, any subframe which no signal is transmitted from RN is used insofar as the subframe is a subframe in which no signal is transmitted from RN, thereby obtaining the same effects as in the embodiment. For example, a subframe in which the amount of traffic in RN is small and there is no signal transmitted from RN, or the like is used. In this case, RN notifies UE under RN that there is a subframe in which no signal is transmitted from RN.

Although in the embodiment, UE under RN has been described, the invention may be applied to UE under eNB. When RN and eNB perform CoMP, UE under eNB measures the CQI of eNB in “the MBSFN subframe to be used as backhaul by RN”. Thus, UE under eNB can improve the measurement precision of the CQI of eNB. In this case, eNB notifies UE under eNB of the position of “the MBSFN subframe to be used as backhaul RN for CoMP”.

In the embodiment, as the method of feeding back the CQI of the adjacent cell, any method of aperiodic CQI feedback and periodic CQI feedback in LTE may be used. The feedback may be performed by other methods.

In the case of aperiodic CQI, an instruction to measure and feed back the CQI is given in the control information (PDCCH) of the downlink channel. In the embodiment, with regard to the CQI of the adjacent cell, an instruction is given in PDCCH, and feedback is performed, thereby realizing aperiodic CQI. In the case of periodic CQI, CQI feedback is performed in a feedback period notified in control information of an upper level layer. In the embodiment, with regard to the CQI of the adjacent cell, a feedback period is notified by the upper level layer, and feedback is performed, thereby realizing periodic CQI.

In the embodiment, when the above-described periodic CQI is applied, in LTE, the feedback interval of the CQI becomes any one of [2, 5, 10, 20, 40, 80, and 160 msec]. Thus, a subframe to be fed back, not the feedback interval, is set in a table form, and the table is associated with “the MBSFN subframe to be used as backhaul by RN”. Thus, the table of the subframe in which the CQI feedback interval is fed back is notified without notifying “the MBSFN subframe to be used as backhaul by RN”, thereby realizing CQI measurement of the adjacent cell in the embodiment. Therefore, it is possible to reduce the overheads of signaling which notifies “the MBSFN subframe to be used as backhaul by RN”.

Although in the embodiment, eNB and RN which is connected to eNB have been described, the invention may be applied to a case where there is a subframe in which no signal is transmitted from one eNB from among a plurality of eNBs.

In the embodiment, a case has been described where CoMP is performed between RN and eNB to which RN is connected. However, CoMP may be performed between a plurality of RNs. In this case, the position of “the MBSFN subframe to be used as backhaul by RN” may differ between RNs. This is because (1) the capacity of backhaul in RN differs between RNs, such that the number of “MBSFN subframes to be used as backhaul by RN” is not identical in each RN, and (2) if the backhauls of a plurality of RNs are in the same subframe, traffic is concentrated, and a sufficient number of resources may not be allocated to each RN, causing degradation in efficiency.

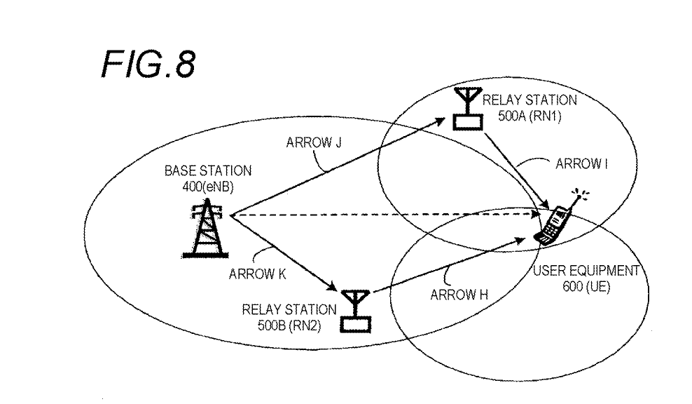

In a modification of the embodiment, focusing on that the position of “the MBSFN subframe to be used as backhaul by RN” differs between RNs, one RN measures the channel quality of another RN in “the MBSFN subframe to be used as backhaul by RN”, such that the channel quality is measured with low interference. Hereinafter, the modification of the embodiment is described in detail with reference to FIGS. 8 to 12.

<Modification>

FIG. 8 is a diagram showing a wireless communication system, which relays a radio signal using a relay technique, in a modification of the embodiment. In FIG. 8, eNB denotes a base station 400, RN1 denotes a wireless relay station apparatus 500A, RN2 denotes a wireless relay station apparatus 500B, and UE denotes a wireless communication terminal 600.

Hereinafter, in the modification of the embodiment, a case where a radio signal is relayed as shown in FIG. 8 is described. As shown in FIG. 8, the base station 400 (hereinafter, referred to as eNB), the relay station 500A (hereinafter, referred to as RN1), and the relay station 500B (hereinafter, referred to as RN2) transmit data to one user equipment 600 (hereinafter, referred to as UE) in a coordinated manner, as indicated by arrows H and I. RN1 and RN2 receive signals from eNB in the backhaul channel (in the figure, arrows J and K). It is assumed that UE is connected to RN1, and CoMP is performed between RN1 and RN2.

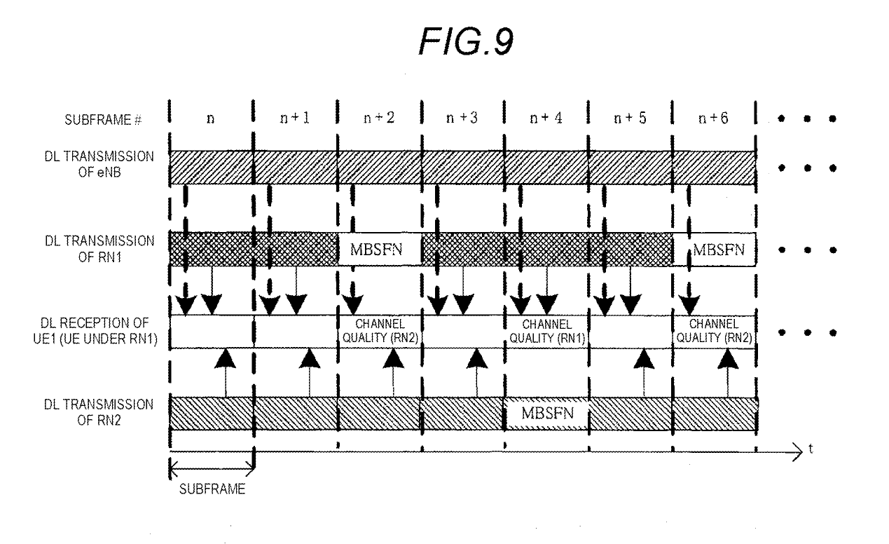

Next, a downlink channel subframe in the wireless communication system shown in FIG. 8 is described with reference to FIG. 9. FIG. 9 is a diagram showing a downlink channel subframe in the modification of the embodiment. In the figure, symbols [n, n+1, . . . ] represent subframe numbers, and boxes represent downlink channel subframes.

As shown in FIG. 9, in RN1, the position of “the MBSFN subframe to be used as backhaul by RN” is the subframes [n+2, n+6]. In RN2, the position of “the MBSFN subframe to be used as backhaul by RN” is the subframe [n+4].

Here, since RN1 does not transmit a downlink signal to UE in the subframes [n+2, n+6], UE can measure the channel quality of RN2 without interference from RN1 connected to UE. Since RN2 does not transmit a downlink signal to UE in the subframe [n+4], UE can measure the channel quality of RN1 without interference from RN2.

In the modification of the embodiment, RN1 notifies UE under RN1 of the position of “the MBSFN subframe to be used as backhaul by RN” in RN1 and RN2 serving as a candidate for CoMP. UE under RN1 measures the channel quality of RN1, that is, the CQI for CoMP using a signal of a region since the third symbol in “the MBSFN subframe to be used as backhaul by RN” of RN2.

Hereinafter, a method of measuring a CQI for CoMP in the modification of the embodiment is described with reference to FIGS. 8 and 9.

First, in FIG. 8, RN1 notifies UE under RN1 of the position of “the MBSFN subframe to be used as backhaul by RN” in all RNs which can serve as a candidate for CoMP with RN1. As a notification method, for example, there is a method in which a notification is made using system information (System Information Block), control information of an upper level layer, or the like.

Next, as in the first embodiment, UE under RN1 provides a channel quality measurement mode in which the channel quality is measured using a region since the third symbol excluding the top two symbols in the subframe. In one RN, the channel quality from another RN to UE is measured in “the MBSFN subframe to be used as backhaul by RN”.

For example, the wireless communication environment which is assumed in FIGS. 8 and 9 is described. In the subframes [n+2, n+6] serving as the MBSFN subframe which is used as backhaul by the subframe of RN1, UE measures the channel quality from RN2 to UE, and in the subframe [n+2] serving as the MBSFN subframe which is used as backhaul by the subframe of RN2, UE measures the channel quality from RN1 to UE.

In the modification of the embodiment, the measurement method of the CQI for CoMP described with reference to FIGS. 8 and 9 is used, in UE under RN, it is possible to measure the channel quality of one RN with satisfactory precision without interference from another RN. For this reason, when CoMP is performed between a plurality of RNs, channel control based on the channel quality is performed.

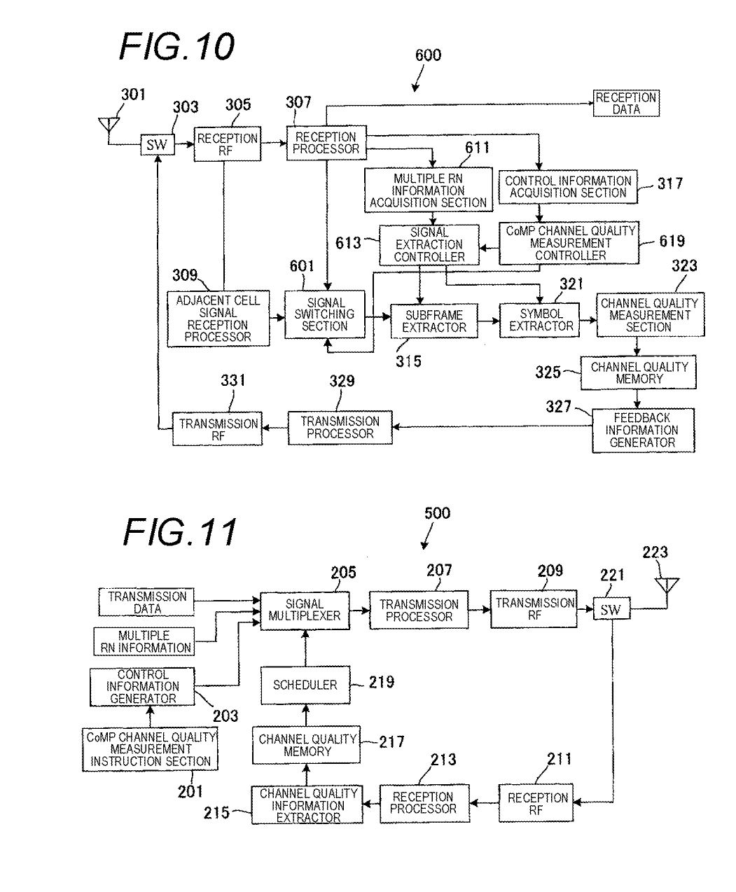

Next, the configuration of the wireless communication terminal 600 in the modification of the embodiment is described with reference to FIG. 10. FIG. 10 is a block diagram showing the configuration of the wireless communication terminal 600 in the modification of the embodiment. The wireless communication terminal 600 shown in FIG. 10 includes an antenna 301, a switch (SW) 303, a reception RF section 305, a reception processor 307, an adjacent cell signal reception processor 309, a signal switching section 601, a control information acquisition section 317, a CoMP channel quality measurement controller 619, a multiple RN information acquisition section 611, a signal extraction controller 613, a subframe extractor 315, a symbol extractor 321, a channel quality measurement section 323, a channel quality memory 325, a feedback information generator 327, a transmission processor 329, and a transmission RF section 331.

The wireless communication terminal 600 shown in FIG. 10 is different from the wireless communication terminal 300 shown in FIG. 5 in that the RN information acquisition section 311 is substituted with the multiple RN information acquisition section 611, and the signal switching section 601 is further provided. The CoMP channel quality measurement controller 619 and the signal extraction controller 613 perform different operations. Other configuration is the same as the wireless communication terminal 300 of the embodiment. In FIG. 10, the constituent elements common to FIG. 5 are represented by the same reference numerals. Description of the constituent elements common to FIG. 5 is omitted.

When there is an instruction to perform the quality measurement of the adjacent cell for CoMP in the control information for the wireless communication terminal 600 output from the control information acquisition section 317, the CoMP channel quality measurement section 619 notifies an instruction to perform the quality measurement of the current cell and the adjacent cell to the signal extraction controller 613 and the signal switching section 601. The determination on whether to measure the quality of the current cell or the adjacent cell may be instructed in the control information or the wireless communication terminal 600 may determine switching.

The multiple RN information acquisition section 611 acquires information relating to all RNs serving as a candidate for CoMP separated in the reception processor 307, and outputs the information to the signal extraction controller 613. The information relating to RN includes the position of “the MBSFN subframe to be used as backhaul by RN” in each RN.

The signal extraction controller 613 outputs an instruction to the subframe extractor 315 and the symbol extractor 321 on the basis of the instruction of the CoMP channel quality measurement controller using the information relating to each RN serving as a CoMP candidate output from the multiple RN information acquisition section 611.

When the CoMP channel quality measurement controller 619 instructs to perform the quality measurement of the adjacent cell, the signal extraction controller 613 instructs the subframe extractor 315 to extract “the MBSFN subframe to be used as backhaul by the current cell (one RN)” output from the multiple RN information acquisition section 611 from the signal output from the signal switching section 601 described below. The signal extraction controller 613 instructs the symbol extractor to a region since the third symbol excluding the top two symbols in the “the MBSFN subframe to be used as backhaul by the current cell (one RN)”.

When the CoMP channel quality measurement controller 619 instructs to perform the quality measurement of the current cell, the signal extraction controller 613 instructs the subframe extractor 315 to extract “the MBSFN subframe to be used as backhaul by the adjacent cell (another RN)” output from the multiple RN information acquisition section 611 from the signal output from the signal switching section 601. The signal extraction controller 613 instructs the symbol extractor 321 to extract a region since the third symbol excluding the top two symbols in “the MBSFN subframe to be used as backhaul by the adjacent cell (another RN)”.

The signal switching section 601 performs switching between a signal of the adjacent cell output from the adjacent cell signal reception processor 309 and a signal of the current cell output from the reception processor 307 on the basis of the instruction of the CoMP channel quality measurement section 619. When the CoMP channel quality measurement controller 619 instructs to perform the quality measurement of the adjacent cell, the signal of the adjacent cell output from the adjacent cell signal reception processor 309 is output. When there is an instruction to perform the quality measurement of the current cell, the signal of the current cell output from the reception processor 307 is output.

In the channel quality measurement section 323, the channel quality memory 325, and the feedback information generator 327, in addition to the process relating to the channel quality of the adjacent cell in the embodiment, the same process is performed with respect to the channel quality of the current cell.

Next, the configuration of the wireless relay station apparatus 500 in the modification of the embodiment is described with reference to FIG. 11. FIG. 11 is a block diagram showing the configuration of the wireless relay station apparatus 500 in the modification of the embodiment. The wireless relay station apparatus 500 shown in FIG. 11 includes a CoMP channel quality measurement instruction section 201, a control information generator 203, a signal multiplexer 205, a transmission processor 207, a transmission RF section 209, a reception RF section 211, a reception processor 213, a channel quality information extractor 215, a channel quality memory 217, and a scheduler 219.

The relay station apparatus 500 shown in FIG. 11 is different from the relay station apparatus 200 shown in FIG. 6 in that the RN information is substituted with multiple RN information. Other configuration is the same as the wireless relay station apparatus 200 of the embodiment. In FIG. 11, the constituent elements common to FIG. 6 are represented by the same reference numerals. Description of the constituent elements common to FIG. 6 is omitted.

The multiple RN information is information relating to RN serving as a candidate for CoMP with the wireless relay apparatus 500 and the wireless relay station apparatus 500, and is input to the signal multiplexer 205.

In the channel quality information extractor 215, the channel quality memory 217, and the scheduler 219, in addition to the process relating to the channel quality of the adjacent cell in the embodiment, the same process is performed with respect to the channel quality of the current cell.

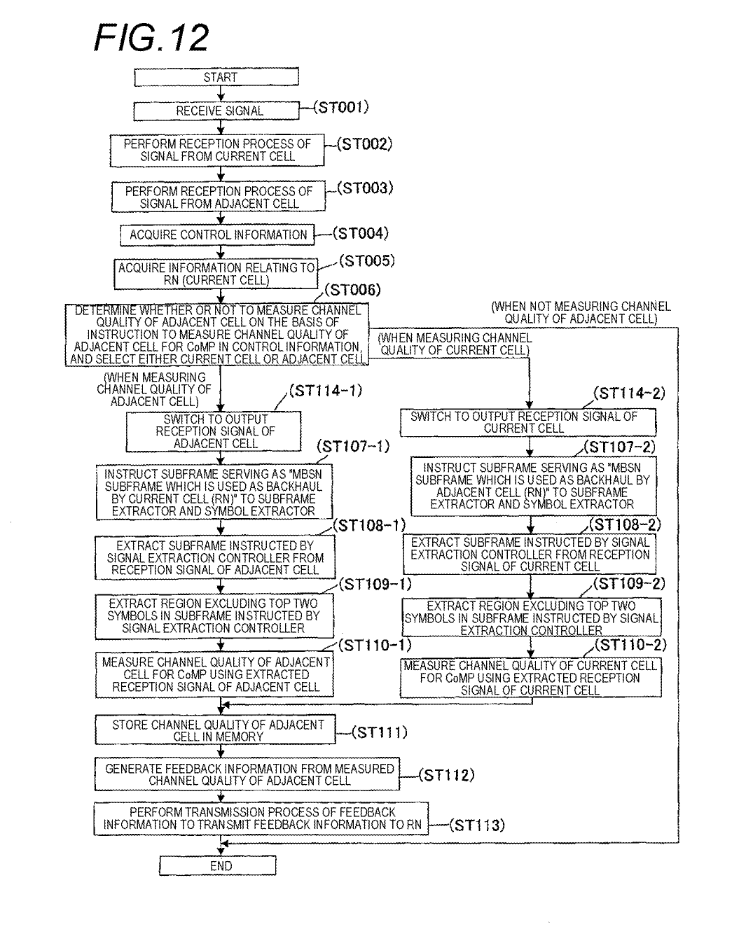

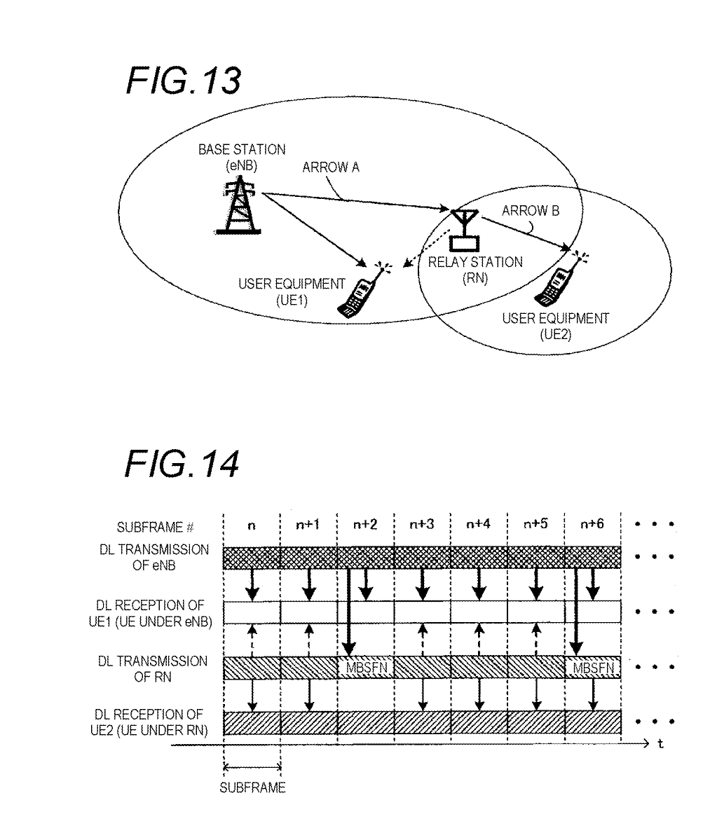

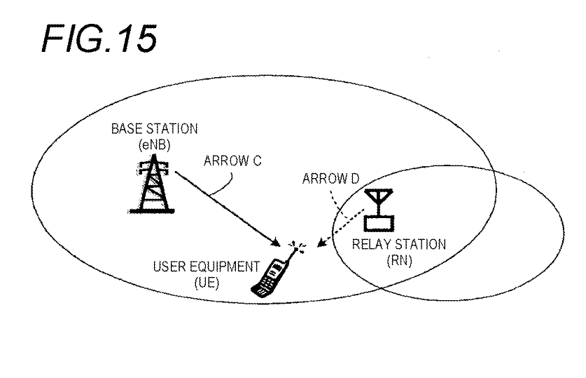

Next, a process flow of channel quality measurement for CoMP in the wireless communication terminal 600 of the modification of the embodiment is described with reference to FIG. 12. FIG. 12 is a diagram showing a process flow of channel quality measurement for CoMP in UE.

The process flow of channel quality measurement for CoMP in UE shown in FIG. 12 basically performs the same process as the process flow of channel quality measurement for CoMP in UE shown in FIG. 7 in the same step. The process flow of channel quality measurement for CoMP in UE shown in FIG. 12 is different from the process flow of channel quality measurement for CoMP in UE shown in FIG. 7 in that the process of Step (ST114-1) and (ST114-2) is further provided and the process of Step (ST006) is different. Other configuration is the same as the process flow of channel quality measurement for CoMP in UE shown in FIG. 7. In FIG. 12, the steps common to FIG. 7 are represented by the same reference numerals.

In Step (ST001), the reception RF section 305 receives signals and performs a reception RF process.

In Step (ST002), the reception processor 307 performs a reception process of receiving a signal from the current cell from among the signals subjected to the reception RF process in Step (ST001).

In Step (ST003), the adjacent cell signal reception processor 309 performs a reception process of receiving a signal from the adjacent cell from among the signals subjected to the reception RF process in Step (ST001).

In Step (ST004), the control information acquisition section 317 acquires control information for UE from the signal received in Step (ST002).

In Step (ST005), the RN information acquisition section 311 acquires information relating to a plurality of RNs from the signal received in Step (ST002).

In Step (ST006), the CoMP channel quality measurement controller 319 determines whether or not to measure the channel quality for CoMP on the basis of an instruction to measure the channel quality for CoMP with respect to the wireless communication terminal 600 by the control information acquired in Step (ST004), and selects whether to measure the quality of the current cell or the adjacent cell. When measuring the channel quality of the adjacent cell for CoMP, the process progresses to Step (ST114-1), and when measuring the channel quality of the current cell, the process progresses to Step (ST114-2). When the channel quality is not measured, the process ends.

<When Measuring Channel Quality of Adjacent Cell>

In Step (ST114-1), the signal switching section 601 performs switching to output a received signal from the adjacent cell processed in Step (ST103).

In Step (ST107-1), the signal extraction controller 313 instructs a subframe serving as “the MBSFN subframe to be used as backhaul by RN” from the information relating to a plurality of RNs acquired in Step (ST005) to the subframe extractor 315 and the symbol extractor 321.

In Step (ST108-1), the subframe extractor 315 extracts the subframe from the signal of the adjacent cell processed in Step (ST003) in the subframe serving as “the MBSFN subframe to be used as backhaul by RN” instructed from the signal extraction controller 313 in Step (ST107-1).

In Step (ST109-1), the symbol extractor 321 extracts a signal of a region excluding the top two symbols from the signal of the subframe extracted in Step (ST108-1) in the subframe serving as “the MBSFN subframe to be used as backhaul by RN” notified from the signal extraction controller 313 in Step (ST107-1).

In Step (ST110-1), the channel quality measurement section 323 performs the channel quality measurement of the adjacent cell for CoMP using the signal extracted in Step (ST109-1).

<When Measuring Channel Quality of Current Cell>

In Step (ST114-2), the signal switching section 601 performs switching to output a received signal from the current cell processed in Step (ST002).

In Step (ST107-2), the signal extraction controller 313 instructs a subframe serving as “MBSFN subframe to be used as backhaul by RN” from the information relating to a plurality of RNs acquired in Step (ST005) to the subframe extractor 315 and the symbol extractor 321.

In Step (ST108-2), the subframe extractor 315 extracts the subframe from the signal of the adjacent cell processed in Step (ST003) in the subframe serving as “MBSFN subframe to be used as backhaul by RN” instructed from the signal extraction controller 313 in Step (ST107-2).

In Step (ST109-2), the symbol extractor 312 extracts a signal of a region excluding the top two symbols from the signal of the subframe extracted in Step (ST108-2) in the subframe serving as “the MBSFN subframe to be used as backhaul by RN” notified from the signal extraction controller 313 in Step (ST107-2).

In Step (ST110-2), the channel quality measurement section 323 performs the channel quality measurement of the adjacent cell for CoMP using the signal extracted in Step (ST109-2).

In Step (ST111), the channel quality memory 325 stores the channel quality of the adjacent cell for CoMP measured in Step (ST110-1) or Step (ST110-2).

In Step (ST112), the feedback information generator 327 generates feedback information from the channel quality of the adjacent cell for CoMP stored in Step (ST111).

In Step (ST113), the transmission processor 329 and the transmission RF section 331 perform a transmission process of transmitting the feedback information generated in Step (ST112) to transmit the feedback information to RN.

As described above, in the modification of the embodiment, if the measurement method of the CQI for CoMP described with reference to FIGS. 8 and 9 is used, in UE under RN, it is possible to measure the channel quality of one RN with satisfactory precision without interference from another RN. For this reason, when CoMP is performed between a plurality of RNs, channel control based on the channel quality is performed.

Although in the modification of the embodiment, a case has been described where CoMP is performed between two RNs, the invention may be applied to CoMP between three or more RNs. In this case, UE measures the channel quality from RN other than RN which uses the MBSFN subframe as backhaul. The invention may be applied to CoMP between two RNs and eNB. In this case, UE measures the channel quality from eNB in the subframe in which RN uses the MBSFN subframe as backhaul.

Although in the foregoing embodiments, description has been provided as to the antennas, the invention may also be applied to antenna ports. An antenna port refers to a logical antenna which is constituted by one or a plurality of physical antennas. That is, an antenna port is not limited to referring to one physical antenna, and may refer to an array antenna or the like having a plurality of antennas. For example, in LTE, while how many physical antennas constitute an antenna port is not defined, an antenna port is defined as the minimum unit such that a base station can transmit different reference signals. An antenna port may be defined as the minimum unit for multiplying the weight of a precoding vector.

Each function block employed in the description of each of the aforementioned embodiments may typically be implemented as an LSI constituted by an integrated circuit. These may be individual chips or partially or totally contained on a single chip. LSI is adopted here but this may also be referred to as IC, system LSI, super LSI, or ultra LSI depending on differing extents of integration.

The method of circuit integration is not limited to LSI, and implementation using dedicated circuitry or general purpose processors is also possible. After LSI manufacture, the utilization of an FPGA (Field Programmable Gate Array) or a reconfigurable processor where connections and settings of circuit cells in an LSI can be reconfigured is also possible.

With the advancement of semiconductor technology or other derivative technologies, if an integrated circuit technology comes out to replace LSI, it is naturally also possible to perform function block integration using this technology. The application of biotechnology is also possible.

Although the invention has been described in detail or with reference to the specific embodiments, it will be apparent to those skilled in the art that various changes or modifications may be made without departing from the spirit and scope of the invention.

This application is based on Japanese Patent Application No. 2009-119105, filed on May 15, 2009, the contents of which are incorporated herein by reference.

### INDUSTRIAL APPLICABILITY

The wireless communication terminal and the wireless communication method according to the invention have an advantage of measuring the channel quality of adjacent cells with satisfactory precision without interference of the current cell, and are useful as a wireless communication terminal or the like.

### REFERENCE SIGNS LIST

100, 400: base station
200, 500A, 500B: wireless relay station apparatus
201: CoMP channel quality measurement instruction section
203: control information generator
205: signal multiplexer
207: transmission processor
209: transmission RF section
211: reception RF section
213: reception processor
215: channel quality information extractor
217: channel quality memory
219: scheduler
221: switch
223: antenna
300, 600: wireless communication terminal
301: antenna
303: switch (SW)
305: reception RF section
307: reception processor
309: adjacent cell signal reception processor
311: RN information acquisition section
313, 613: signal extraction controller
315: subframe extractor
317: control information acquisition section
319, 619: CoMP channel quality measurement controller
321: symbol extractor
323: channel quality measurement section
325: channel quality memory
327: feedback information generator
329: transmission processor
331: transmission RF section
601: signal switching section
611: multiple RN information acquisition section

1. A wireless communication terminal which is connected to a first relay station and configured to receive data from at least one of the first relay station, a non-connected base station, and a non-connected second relay station different from the first relay station, the wireless communication terminal comprising:
a receiver which receives a signal including control information for measuring a channel quality of the base station or the second relay station from the first relay station;
an extractor which extracts the control information from the signal received by the receiver;
a measurement section which measures the channel quality of the base station or the second relay station in a region, in which the first relay station does not transmit another signal to the wireless communication terminal, based on the control information; and
a transmitter which transmits a measurement result of the channel quality of the base station or the second relay station measured by the measurement section to the first relay station.

2. The wireless communication terminal according to claim 1,
wherein the measurement section measures the channel quality of the base station or the second relay station in a region, in which the first relay station receives a signal from the base station as backhaul, based on the control information.

3. The wireless communication terminal according to claim 2,
wherein the measurement section measures the channel quality of the base station or the second relay station in an MBSFN subframe to be used by the first relay station as the backhaul, based on the control information.

4. The wireless communication terminal according to claim 3,
wherein the measurement section measures the channel quality of the base station or the second relay station in a region since a third symbol excluding top two symbols in the MBSFN subframe to be used by the first relay station as the backhaul, based on the control information.

5. The wireless communication terminal according to claim 1,
wherein the measurement section measures the channel quality of the base station or the second relay station multiple times in the region, in which the first relay station does not transmit the another signal to the wireless communication terminal, based on the control information, and averages measurement results.

6. The wireless communication terminal according to claim 1,
wherein the measurement section measures the channel quality of the second relay station in a region since a third symbol excluding top two symbols in an MBSFN subframe to be used by the first relay station as backhaul, based on the control information, and
the measurement section measures the channel quality of the first relay station in a region since a third symbol excluding top two symbols in an MBSFN subframe to be used as backhaul by the second relay station.

7. A wireless communication method for a wireless communication terminal, which is connected to a first relay station and configured to receive data from at least one of the first relay station, a non-connected base station, and a non-connected second relay station different from the first relay station, the wireless communication method comprising:
receiving a signal including control information for measuring a channel quality of the base station or the second relay station from the first relay station;
extracting the control information from the received signal;
measuring the channel quality of the base station or the second relay station in a region, in which the first relay station does not transmit another signal to the wireless communication terminal, based on the control information; and
transmitting a measurement result of the channel quality of the base station or the second relay station to the first relay station.
